(19) United States
(12) Patent Application Publication
(10) Pub. No.: US 2025/0315579 A1
(43) Pub. Date: Oct. 9, 2025

(54) METHOD AND APPARATUS FOR OPTIMIZING DESIGN BASED ON PERFORMANCE EVALUATION OF GAS DIFFUSION LAYER OF FUEL CELL

(71) Applicants: CATARC NEW ENERGY VEHICLE TEST CENTER (TIANJIN) CO., LTD., Tianjin (CN); CHINA AUTOMOTIVE TECHNOLOGY AND RESEARCH CENTER CO., LTD., Tianjin (CN)

(72) Inventors: Daokuan JIAO, Tianjin (CN); Dong HAO, Tianjin (CN); Yanyi ZHANG, Tianjin (CN); Zhixin WU, Tianjin (CN); Yongping HOU, Tianjin (CN); Ji PU, Tianjin (CN); Zirong YANG, Tianjin (CN); Xin ZHAO, Tianjin (CN); Ruidi WANG, Tianjin (CN); Wenyan DONG, Tianjin (CN)

(73) Assignees: CATARC NEW ENERGY VEHICLE TEST CENTER (TIANJIN) CO., LTD., Tianjin (CN); CHINA AUTOMOTIVE TECHNOLOGY AND RESEARCH CENTER CO., LTD., Tianjin (CN)

(21) Appl. No.: 19/172,613

(22) Filed: Apr. 7, 2025

(30) Foreign Application Priority Data
Apr. 7, 2024 (CN) 202410407818.9

(51) Int. Cl. G06F 30/28; H01M 8/023

(52) U.S. Cl. CPC G06F 30/28; H01M 8/023

(57) ABSTRACT

The present disclosure relates to a field of a fuel cell test, and in particular, to a method and an apparatus for optimizing design based on performance evaluation of a gas diffusion layer of a fuel cell. The method includes: determining an overall porosity of the gas diffusion layer of the fuel cell according to production requirements, and obtaining a plurality of porosity structures with the overall porosity; obtaining performance evaluation indexes of the gas diffusion layer of the fuel cell, and constructing a performance evaluation system for the gas diffusion layer of the fuel cell; calculating, with reference to evaluation functions and index weight ratios, performance comprehensive scores of the plurality of porosity structures in the performance evaluation system of the gas diffusion layer of the fuel cell; determining an optimal design scheme in the plurality of porosity structures according to the performance comprehensive scores.

### CROSS-REFERENCE TO RELATED APPLICATION

This application claims priority to Chinese application No. 202410407818.9, filed on Apr. 7, 2024, which is incorporated herein by reference in its entirety.

### TECHNICAL FIELD

The present disclosure relates to the field of the fuel cell test, and in particular, to a method and an apparatus for optimizing design based on performance evaluation of a gas diffusion layer of the fuel cell.

### BACKGROUND

To improve water and heat management performance of a fuel cell, a structure of a gas diffusion layer needs to be continuously optimized. For example, a gas diffusion layer with a porosity of 0.7 may include design schemes in a plurality of structural forms.

Although an overall porosity is 0.7, respective internal layers have different structures. The porosity of each layer from the upper layer to the lower layer may be linearly reduced, may be linearly increased, or may be randomly distributed or evenly distributed. Therefore, porosity of respective layers also varies greatly. The gas-water-heat-electric transmission characteristics inside the gas diffusion layer are significantly different in various design schemes.

For design scheme of the gas diffusion layer with uneven porosity distribution, the output performance indexes may be balanced, and the design scheme of a-stepped porosity or an ordered porosity structure may be more single or prominent. In conclusion, under an overall porosity design, the porosity design of respective local layers may include a variety of combinations. However, when a production end selects an overall porosity according to a requirement, how to design a local porosity in respective layers to implement performance output equalization and optimization is a key problem in current optimization design of the fuel cell. In the prior art, there is no fuel cell optimization design scheme evaluated according to a performance index of a porosity.

### SUMMARY

A main objective of the present disclosure is to provide an optimization design scheme based on performance evaluation of a gas diffusion layer of a fuel cell. It is intended to solve a problem in the prior art of how to implement design optimization of a local porosity of a fuel cell to obtain an optimal design scheme.

One or more embodiments of the present disclosure provide a method for optimizing design based on performance evaluation of a gas diffusion layer of a fuel cell, comprising: determining an overall porosity of the gas diffusion layer of the fuel cell according to production requirements, and obtaining a plurality of porosity structures with the overall porosity; obtaining performance evaluation indexes of the gas diffusion layer of the fuel cell, and constructing a performance evaluation system for the gas diffusion layer of the fuel cell; calculating, with reference to evaluation functions and index weight ratios, performance comprehensive scores of the plurality of porosity structures in the performance evaluation system of the gas diffusion layer of the fuel cell; determining an optimal design scheme in the plurality of porosity structures according to the performance comprehensive scores.

One or more embodiments of the present disclosure further provide an apparatus for optimizing design based on performance evaluation of gas diffusion layer of the fuel cell, comprising: at least one processor, and at least one memory, the at least one memory being configured to store computer instructions, and the at least one processor being configured to execute at least a part of instructions in the computer instructions to implement the method for optimizing design based on performance evaluation of a gas diffusion layer of a fuel cell in any embodiment of the present disclosure.

Beneficial technical effects of the embodiments of the present disclosure include but are not limited to: it calculates the performance comprehensive scores of the plurality of porosity structures in the performance evaluation system of the gas diffusion layer of the fuel cell, so as to determine the optimal design scheme in the plurality of porosity structures; it can not only select an optimal fuel cell product design, but also identify a difference of performance indexes between different fuel cell product designs; and a direction of optimal design of the fuel cell product is guided by compensating a shortcoming.

### BRIEF DESCRIPTION OF THE DRAWINGS

The present disclosure will be further illustrated by way of exemplary embodiments that will be described in detail with reference to the accompanying drawings. These exemplary embodiments are not limiting. In these embodiments, the same number represents the same structure, where:

FIG. 1 is an exemplary flowchart of a method for optimizing design based on performance evaluation of a gas diffusion layer of a fuel cell according to some embodiments of the present disclosure;

FIGS. 2A-2C are exemplary schematic structural diagrams of a plurality of porosity structures according to some embodiments of the present disclosure;

FIG. 3 is a schematic diagram of an exemplary comparison of air permeability according to some embodiments of the present disclosure;

FIG. 4 is an exemplary schematic diagram of a drainage capability test apparatus according to some embodiments of the present disclosure;

FIG. 5 is an exemplary schematic diagram of a test result of compression rate according to some embodiments of the present disclosure;

FIG. 6 is an exemplary schematic structural diagram of an apparatus for optimizing design based on performance evaluation of a gas diffusion layer of a fuel cell according to some embodiments of the present disclosure;

FIG. 7 is an exemplary diagram of a test result of thickness uniformity according to some embodiments of the present disclosure;

FIG. 8 is an exemplary diagram of a test result of air permeability according to some embodiments of the present disclosure;

FIG. 9 is an exemplary diagram of a test result of drainage capability according to some embodiments of the present disclosure;

FIG. 10 is an exemplary diagram of a test result of tensile strength according to some embodiments of the present disclosure;

FIG. 11 is an exemplary schematic diagram of a test result of compression characteristic according to some embodiments of the present disclosure;

FIG. 12 is an exemplary schematic diagram of a test result of a planar resistivity according to some embodiments of the present disclosure;

FIG. 13 is an exemplary schematic diagram of a test result of vertical resistivity according to some embodiments of the present disclosure; and

FIGS. 14A-14D are exemplary schematic diagrams of test results of acid corrosion tolerance according to some embodiments of the present disclosure.

### DETAILED DESCRIPTION

To describe the technical solutions of the embodiments in the present disclosure more clearly, the following briefly describes the accompanying drawings required for describing the embodiments. Apparently, the accompanying drawings in the following description are merely some examples or embodiments of the present disclosure. A person of ordinary skill in the art may still apply the present disclosure to another similar scenario according to these accompanying drawings without creative efforts. Unless apparent from the language environment or otherwise stated, the same reference number in the figure represents the same structure or operation.

It should be understood that the “system”, “apparatus”, “unit”, and/or “module” used herein are methods used to distinguish different members, elements, components, parts, or assemblies of different levels. However, if other words can achieve the same purpose, the terms can be replaced by other expressions.

As shown in the present disclosure and the claims, the words “a”, “an”, “one” and/or “the” are not specific singular numbers and may also include plural numbers unless the context expressly suggests exceptions. Generally speaking, the terms “include” and “comprise” indicate only those steps and elements that have been explicitly identified, and these steps and elements do not constitute an exclusive listing, and the method or device may also include other steps or elements.

A flowchart is used in the present disclosure to describe an operation performed by a system according to an embodiment of the present disclosure. It should be understood that the preceding or subsequent operations are not necessarily performed accurately in a sequence. Instead, the steps may be processed in reverse order or simultaneously. At the same time, other operations may be added to these processes, or a step or several operations may be removed from these processes.

The following clearly and completely describes the technical solutions in the embodiments of the present disclosure with reference to the accompanying drawings in the embodiments of the present disclosure. Apparently, the described embodiments are only a part rather than all of the embodiments of the present disclosure. Based on the embodiments of the present disclosure, all other embodiments obtained by a person of ordinary skill in the art without creative efforts fall within the protection scope of the present disclosure.

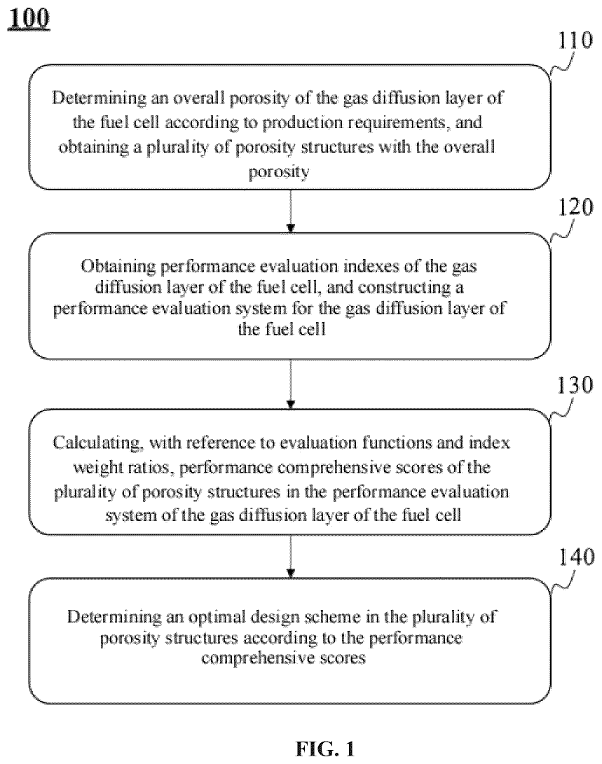

FIG. 1 is an exemplary flowchart of a method for optimizing design based on performance evaluation of a gas diffusion layer of a fuel cell according to some embodiments of the present disclosure.

As shown in FIG. 1, a process 100 includes the following steps. In some embodiments, the process 100 may be executed by a processor.

The processor may process data and/or information obtained from another apparatus/component or constitute. The processor may execute a program instruction based on the data, the information, and/or the processing result to execute the functions described in the embodiments of the present disclosure. By way of example only, the processor may include but is not limited to a central processing unit (CPU), a microprocessor MCU, or any combination thereof. In some embodiments, the processor may include a plurality of modules, and different modules may be configured to separately execute different program instructions.

In some embodiments, the processor may: determine an overall porosity of the gas diffusion layer of the fuel cell according to production requirements, and obtain a plurality of porosity structures at the overall porosity; obtain performance evaluation indexes of the gas diffusion layer of the fuel cell, and construct a performance evaluation system of the gas diffusion layer of the fuel cell; calculate, with reference to evaluation functions and index weight ratios, performance comprehensive scores of the plurality of porosity structures in the performance evaluation system of the gas diffusion layer of the fuel cell; determine an optimal design scheme in the plurality of porosity structures according to the performance comprehensive scores.

In some embodiments, the plurality of porosity structures includes at least a first-stepped porosity structure, a second-stepped porosity structure, and an ordered porosity structure. The first-stepped porosity structure is that the porosity of each layer of the gas diffusion layer decreases linearly from top to bottom. The second-stepped porosity structure is that the porosity of each layer of the gas diffusion layer increases linearly from top to bottom. The ordered porosity structure is that the porosity of each layer of the gas diffusion layer is distributed evenly from top to bottom.

In some embodiments, the performance evaluation indexes of the gas diffusion layer of the fuel cell include at least: characteristic performance indexes, mechanical performance indexes, electrical performance indexes, and durability performance indexes. The characteristic performance indexes include air permeability and a drainage capability of the gas diffusion layer of the fuel cell. The mechanical performance indexes include tensile strength and compression characteristic of the gas diffusion layer of the fuel cell. The electrical performance indexes include vertical resistivity and planar resistivity of the gas diffusion layer of the fuel cell. The durability performance indexes include acid corrosion tolerance of the gas diffusion layer of the fuel cell.

In some embodiments, calculating, with reference to the evaluation functions and the index weight ratios, performance comprehensive scores of the plurality of porosity structures in the performance evaluation system of the gas diffusion layer of the fuel cell, further includes: obtaining an evaluation function for each of the performance evaluation indexes in the gas diffusion layer of the fuel cell, and calculating an evaluation value of each of performance evaluation indexes; assigning an index weight ratio to each of the performance evaluation indexes according to importance of each of the performance evaluation indexes to the fuel cell performance; calculating performance comprehensive scores of the plurality of porosity structures in the performance evaluation system of the gas diffusion layer of the fuel cell; obtaining a performance comprehensive score of the structure design schemes with different porosity distributions by the evaluation functions and index weight ratios to obtain the optimal design scheme.

In some embodiments, a calculation manner of the performance comprehensive score includes: obtaining the performance comprehensive score by means of calculation according to the evaluation value and the index weight ratio of the performance evaluation index, where a calculation manner is as follows:

$$Q = {Σ}_{i = 1}^{11} {Q}_{i} \times {y}_{i}$$

wherein Q represents the performance comprehensive score of the structure design schemes with different porosity distributions; yᵢ represents an index weight ratio of a performance evaluation index whose number is i.

Step 110: determine an overall porosity of the gas diffusion layer of the fuel cell according to the production requirements, and obtain a plurality of porosity structures in the overall porosity.

The production requirements refer to conditions and standards required for products (for example, fuel cells) to be produced. In some embodiments, the production requirements may include conditions or standards in a variety of aspects such as material selection, thickness and porosity, conductivity, mechanical strength, thermal stability, chemical stability, water management, production costs, environmental protection, customization, or the like. In the present disclosure embodiment, the production requirements mainly include a porosity requirement of the gas diffusion layer of the fuel cell.

The gas diffusion layer (GDL) of the fuel cell is one of key components of the fuel cell, and is located between a catalyst layer and a bipolar plate. The main function of the gas diffusion layer of the fuel cell is to uniformly distribute reaction gases (e.g., hydrogen and oxygen), conduct current, manage moisture, and provide mechanical support.

Porosity is a ratio of a pore volume to a total volume in the gas diffusion layer of the fuel cell. The total porosity is a ratio of a total volume of all the pores in the gas diffusion layer of the fuel cell to a total volume of the material.

In some embodiments, the processor may directly obtain the production requirements entered by the user, for example, in a manner of text input, voice input, or the like. The processor may determine an overall porosity according to a porosity requirement in the production requirements for the gas diffusion layer of the fuel cell.

The porosity structure refers to a structure formed by a comprehensive feature of a form, distribution, size, connectivity, and arrangement of pores in the gas diffusion layer of the fuel cell. The plurality of porosity structures may include structures formed by different pore features at a same overall porosity.

In some embodiments, the plurality of porosity structures includes at least a first-stepped porosity structure, a second-stepped porosity structure, and an ordered porosity structure.

The first-stepped porosity structure refers to a structure in which the porosity of each layer of the gas diffusion layer decreases linearly from top to bottom.

The second-stepped porosity structure refers to a structure in which the porosity of each layer of the gas diffusion layer increases linearly from top to bottom.

The ordered porosity structure refers to a structure in which the porosity of each layer of the gas diffusion layer is evenly distributed from top to bottom.

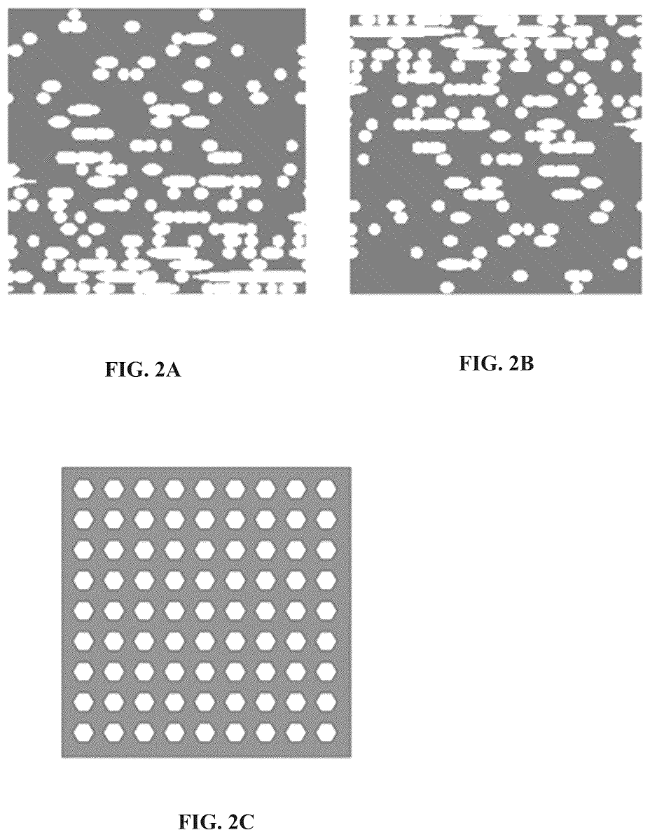

FIGS. 2A-2C are schematic structural diagrams of the plurality of porosity structures according to some embodiments of the present disclosure. In some embodiments, as shown in FIGS. 2A-2C, FIG. 2A is the first-stepped porosity structure, FIG. 2B is the second-stepped porosity structure, and FIG. 2C is the ordered porosity structure.

In some embodiments, the memory may store a plurality of pre-designed porosity structures at a plurality of overall porosity. After determining the overall porosity of the gas diffusion layer of the fuel cell, the processor may invoke the plurality of porosity structures at the overall porosity from the memory.

In some embodiments, the processor may receive the plurality of porosity structures at the overall porosity input by the user. The user may design the plurality of porosity structures according to the overall porosity, and input them to the processor.

Step 120: obtain performance evaluation indexes of the gas diffusion layer of the fuel cell, and construct the performance evaluation system of the gas diffusion layer of the fuel cell.

The performance evaluation indexes are standards or parameters used to describe and evaluate a product (e.g., the gas diffusion layer of the fuel cell).

In some embodiments, the performance evaluation indexes of the gas diffusion layer of the fuel cell include at least the characteristic performance indexes, the mechanical performance indexes, electrical performance indexes, and the durability performance indexes.

The characteristic performance indexes are performance evaluation indexes used to describe and evaluate key performance of the product. In some embodiments, the characteristic performance indexes include the air permeability and the drainage capability of the gas diffusion layer of the fuel cell.

The mechanical performance indexes are performance evaluation indexes used to describe and evaluate the mechanical performance of the product. In some embodiments, the mechanical performance indexes include the tensile strength and the compression characteristic of the gas diffusion layer of the fuel cell.

The electrical performance indexes are performance evaluation indexes used to describe and evaluate the electrical performance of the product. In some embodiments, the electrical performance indexes include the vertical resistivity and the planar resistivity of the gas diffusion layer of the fuel cell. The electrical performance indexes may also include a vertical electrical conductivity and a planar electrical conductivity. The conductivity and the resistivity are reciprocal.

The durability performance indexes are performance evaluation indexes used to describe and evaluate the performance of the product under long-term use or specific conditions. In some embodiments, the durability performance indexes include acid corrosion tolerance of the gas diffusion layer of the fuel cell.

In this embodiment of the present disclosure, for the gas diffusion layer, mechanical performances in different porosity combinations are relatively different from an uppermost layer to a lowermost layer. In terms of production technology, the performance of each carbon fiber is consistent according to the same firing temperature. However, the overall performance varies due to structural differences. Therefore, different porosity structures need to be evaluated in several aspects (e.g., performance evaluation indexes) to obtain the optimal design scheme.

The performance evaluation system is a structural system used to obtain evaluation results of the product (for example, the gas diffusion layer of the fuel cell) under one or more performance evaluation indexes.

In some embodiments, for each of the performance evaluation indexes, the processor may determine a test process corresponding to the performance evaluation index. The processor may construct the performance evaluation system according to test processes corresponding to a plurality of performance evaluation indexes.

In some embodiments, the test process may include an air permeability test process, a drainage capability test process, a tensile strength test process, a compression characteristic test process, a durability test process, a resistivity test process, or the like.

In some embodiments, the air permeability is a core performance index of the gas diffusion layer, and the processor may determine the air permeability test process. In some embodiments, the air permeability test process includes: using an air permeability meter, comparing performance differences of the plurality of porosity structures under the same pressure difference by using a constant pressure difference manner.

The air permeability is a parameter indicating the difficulty of gas passing through the gas diffusion layer under pressure difference. In some embodiments, the air permeability may be determined by a pressure difference manner, a gas permeator, a simulation calculation, or the like. In some embodiments, the air permeability of the gas diffusion layer of the fuel cell is typically between 10⁻¹² m² to 10⁻¹⁰ m².

In some embodiments, for each of the porosity structures, the processor may determine the air permeability corresponding to the porosity structure.

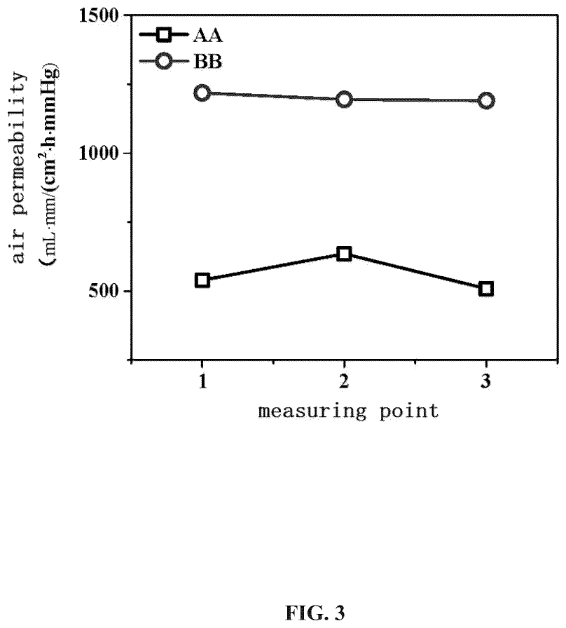

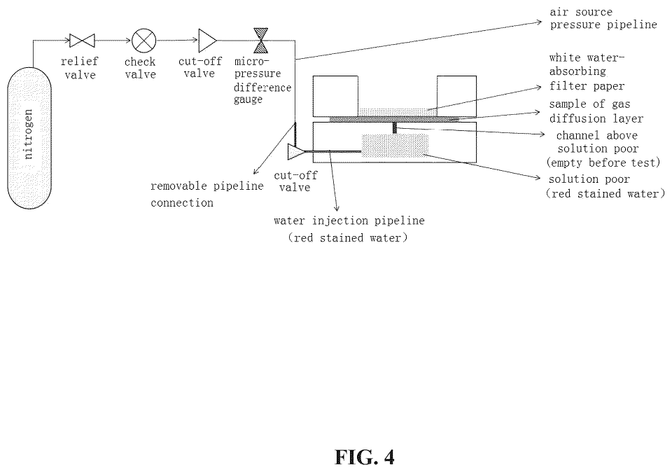

FIG. 3 is a schematic diagram of an exemplary comparison of air permeability according to some embodiments of the present disclosure. In FIG. 3, a horizontal coordinate is a number of a measurement point, and a vertical coordinate is the air permeability. In some embodiments, as shown in FIG. 3, there is a large difference in the air permeability between two different porosity structures of AA and BB at a 20 Pa pressure difference. Therefore, the air permeability corresponding to each of the plurality of porosity structures needs to be determined.

High air permeability means that the gas may pass through the diffusion layer more efficiently, ensuring that the reaction gas reaches the catalyst layer quickly. Low air permeability may limit gas transmission and reduce battery performance, but may help prevent membrane drying. In this embodiment of the present disclosure, by comparing performance differences of the plurality of porosity structures at the same pressure difference, the air permeability corresponding to each porosity structure in the same condition may be determined, so as to screen a porosity structure with appropriate air permeability, which helps to select the optimal design scheme.

In some embodiments, for each of the porosity structures, the processor may determine a drainage capability corresponding to the porosity structure. For example, the processor may determine the drainage capability by means of tests (e.g., visualization tests, pressure drop measurements, electrochemical impedance spectroscopy, etc.) or numerical simulation.

In some embodiments, the processor may represent the drainage capability of the gas diffusion layer of the fuel cell by using a breakthrough pressure of testing liquid water, that is, a drainage capability test process, including: injecting red stained water into a solution pool before testing, and closing a check valve of a water injection pipeline when an injected liquid level reaches a position of a channel above the solution pool; and connecting the water injection pipeline to an air source pressure pipeline, clamping the gas diffusion layer of the fuel cell with the plurality of porosity structures into a test fixture, and disposing a white water-absorbing filter paper in an upper cavity; opening a cut-off valve in the water injection pipeline and a relief valve in the air source pressure pipeline and adjusting to an appropriate pressure; opening the check valve and cut-off valve, slowly adjusting a micro-pressure difference gauge from a low pressure to a high pressure, and recording, a pressure of the micro-pressure difference gauge when the white water-absorbing filter paper turns red, as the breakthrough pressure of the liquid water.

FIG. 4 is an exemplary schematic diagram of a drainage capability test apparatus according to some embodiments of the present disclosure.

In some embodiments, as shown in FIG. 4, the drainage capability test apparatus includes the water injection pipeline, the solution pool, the air source pressure pipeline, and the test fixture.

The water injection pipeline is connected to the solution pool. The water injection pipeline is used to inject the red stained water into the solution pool. The solution pool is used to contain the liquid injected by the water injection pipeline. A channel is disposed above the solution pool. A lower end of the channel is located above the solution pool. An upper end of the channel is connected to the gas diffusion layer of the fuel cell clamped in the test fixture. The test fixture is used to hold and fix the gas diffusion layer of the fuel cell to be tested. The air source pressure pipeline is connected to the water injection pipeline through a removable pipeline connection. The air source pressure pipeline is used to provide gas pressure.

In some embodiments, the drainage capability test apparatus further includes a nitrogen cylinder. The nitrogen cylinder is connected to the air source pressure pipeline by using a relief valve, a check valve, a cut-off valve, and a micro-pressure difference gauge. The nitrogen cylinder provides gas for the air source pressure pipeline. The cut-off valve may also be provided between the air source pressure pipeline and the water injection pipeline.

Due to a capillary pressure of the gas diffusion layer, liquid water may be discharged from the bottom to the top under a certain breakthrough pressure. Therefore, the drainage capability of the gas diffusion layer is represented by testing the breakthrough pressure of the liquid water.

Before the test, it injects the red stained water into the solution pool through the water injection pipeline. When the injected liquid level of the solution pool reaches the channel above the solution pool, the check valve of the water injection pipeline is closed. The check valve of the water injection pipeline prevents liquid or gas reflux.

The water injection pipeline is connected to the gas source pressure pipeline through the removable pipeline connection, and a sample of gas diffusion layer with different porosity is clamped into the test fixture. The white water-absorbing filter paper is put in a cavity above of the sample of gas diffusion layer. The white water-absorbing filter paper may absorb the red stained water discharged from the sample of gas diffusion layer and present a clear color.

The cut-off valve of the water injection pipeline and the relief valve of the air source pressure pipeline are opened to adjust to the appropriate pressure. The cut-off valve may control the water injection pipeline to inject the red stained water into the solution pool. After the cut-off valve is opened, the water injection pipeline stops injecting the red stained water into the solution pool. The relief valve may adjust the pressure in the air source pipeline. After the appropriate pressure is applied, the pressure at both ends of the solution pool (that is, one end of the upper channel and one end of the water injection pipeline) may be balanced.

The check valve and cut-off valve of the water injection pipeline are opened to adjust the micro-pressure difference gauge (slowly adjust from a low pressure to a high pressure), and the pressure of the micro-pressure difference gauge is recorded as a breakthrough pressure when the white-absorbing filter paper turns red. After the check valve and cut-off valve are opened, the gas in the nitrogen cylinder may be transferred to the solution pool according to the control of the micro-pressure difference gauge to gradually boost the pressure, so that the pressure of the red stained water absorbed by the white water-absorbing filter paper through the channel above the solution pool and the gas diffusion layer under pressure is measured, that is, the breakthrough pressure is measured. In this case, the breakthrough pressure may represent the drainage capability of the gas diffusion layer of the fuel cell.

The product water of the fuel cell needs to be discharged efficiently, so as to prevent the gas transmission channel from blocking, causing the battery to be “flooded”. However, the gas diffusion layer under the same processing condition may have different drainage capability due to different structural characteristics. Insufficient drainage capacity may cause flooding, hinder gas transmission, and reduce battery performance. Excessive drainage capacity may cause membrane drying and affect battery efficiency. Therefore, in this embodiment of the present disclosure, by using the foregoing drainage capability test process and the drainage capability test apparatus, the drainage capability of a plurality of porosity structures can be determined, so as to screen a porosity structure with the appropriate drainage capability, which helps to select an optimal design scheme.

In some embodiments, for each of the porosity structures, the processor may determine the tensile strength and/or the compression characteristic corresponding to the porosity structure.

The tensile strength refers to the ability of the material to resist fracture during tensile process. The tensile strength reflects the manufacturing process characteristics of the gas diffusion layer of the fuel cell. The tensile strength depends on the strength of the carbon fiber itself and the strength of the impregnated binder after carbonizing.

In some embodiments, the tensile strength test process may include: performing a test by using a universal tester to obtain the tensile strength. The universal tester may measure the performance of the material by applying a controlled tension or compression force.

The compression characteristic is a characteristic of a material that is subjected to a compression force. In some embodiments, the compression characteristic may be obtained by compression characteristic testing, for example, by applying a progressively increased compression force by the universal tester.

In some embodiments, the compression characteristic test process may include: obtaining the compression characteristic by calculating a difference between an initial thickness without pressure and a thickness after being compressed for a plurality of times of the gas diffusion layer of the fuel cell with the plurality of porosity structures.

In some embodiments, the compression characteristic test process may further include: repeatedly applying pressure (e.g., 1.0 MPa) on the outside of a pressure plate; recording a compression rate obtained by means of a plurality of measurements, such as a first compression rate, a second compression rate, and a third compression rate; determining the compression characteristic based on the compression rates obtained by means of the plurality of measurements.

In some embodiments, the compression rate may be determined based on an initial average thickness of the sample and a thickness of the sample at applied pressure (e.g., 1.0 MPa). For example, the compression rate may be obtained by means of calculation according to the following formula (1):

$${γ}_{n} = \frac{\overline{d} - {d}_{p i}}{\overline{d}} \times 100 \% \qquad ( 1 )$$

γₙ represents a nth compression rate, d̅ represents an initial thickness (μm) of the sample without pressure, and dₚᵢ represents the thickness (μm) of the sample at the nth applied pressure (e.g., 1.0 MPa).

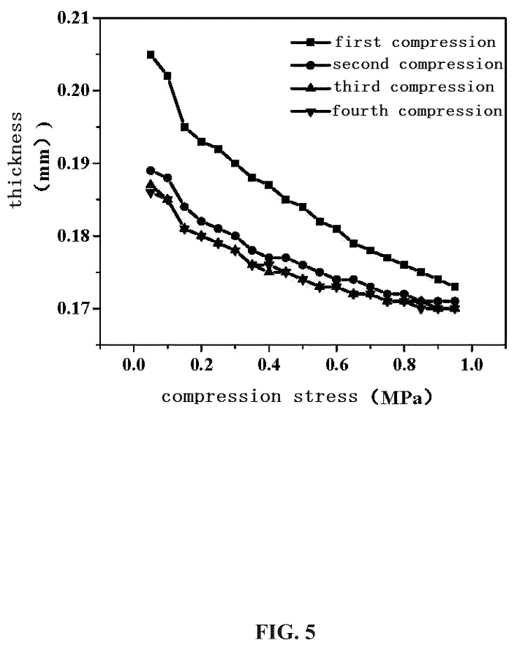

FIG. 5 is an exemplary schematic diagram of a test result of the compression rate according to some embodiments of the present disclosure. In FIG. 5, a horizontal coordinate is a compressive stress of a sample, and a vertical coordinate is a thickness of the sample.

In a conventional compression test, the first compression rate γ₁ is generally used for calculation. However, because the initial thickness of the sample changes obviously after repeated compressions, in some embodiments, as shown in FIG. 5, a difference between an initial thickness d̅ without pressure and a thickness d̅_{compressed} obtained after a plurality of compressions of the sample is calculated, and the nth compression rate (n≥2) is used as the compression characteristic θ. For example, the compression characteristic θ may be obtained by means of calculation according to the following formula (2):

$$θ = \frac{\overline{d} - {\overline{d}}_{c o m p r e s s e d}}{\overline{d}} \times 100 \% \qquad ( 2 )$$

d̅ represents the initial thickness (μm) of the sample without pressure, and d̅_{compressed} represents the thickness after nth compression.

In this embodiment of the present disclosure, the tensile strength and compression characteristic are important indexes for evaluating the performance of the gas diffusion layer of the fuel cell. In addition to initial compression performance, repeated compression and resilience of the gas diffusion layer is of great significance to the fuel cell assembly process and performance consistency. By means of comprehensive testing of the tensile strength and the compression characteristic, the tensile strength and the compression characteristic of the plurality of porosity structures can be determined, so as to screen a porosity structure with appropriate tensile strength and compression characteristic, and ensure excellent mechanical performance and stability of the gas diffusion layer in the fuel cell, which helps to select the optimal design scheme.

In some embodiments, for each of the porosity structures, the processor may determine the durability corresponding to the porosity structure, such as acid corrosion tolerance.

Acid corrosion tolerance refers to the ability of the material to resist chemical corrosion in an acid environment. In some embodiments, the acid corrosion tolerance may include a variation range of thickness uniformity, a variation range of planar resistivity, a variation range of tensile strength, a variation range of air permeability, or the like, of the gas diffusion layer of the fuel cell before and after acid corrosion. The differences between the thickness uniformity, the planar resistivity, the tensile strength, and the air permeability before the acid corrosion and the corresponding indexes after the acid corrosion may be calculated to obtain the variation range of thickness uniformity, the variation range of planar resistivity, the variation range of tensile strength, and the variation range of air permeability. For the thickness uniformity, the planar resistivity, the tensile strength and the air permeability, refer to the descriptions of related indexes in the present disclosure.

In some embodiments, acid corrosion tolerance test process may include an immersion test, an electrochemical test, a long-term exposure tests, or the like. The immersion test is to immerse the material in an acid solution (such as sulfuric acid and phosphoric acid) and observe the corrosion. The electrochemical test is to measure the corrosion current and corrosion potential of the material in the acidic environment, and evaluate the corrosion resistance. The long-term exposure test refers to placing the material in the simulated operation environment of the fuel cell, and observing the performance change of the material for a long time.

Merely by way of example, the conditions for acid corrosion test may be set as follows: place the sample in a 15% H₂O₂+1 mol/LH₂SO₄ mixed solution container, place the sample in a constant temperature water bath at 80° C. for 20 days, seal the container containing the solution, and observe the amount of the mixed solution. If it is found that the solution is insufficient, add it in time.

Durability is an important factor for measuring the performance stability of the gas diffusion layer and the life of the fuel cell. The embodiments of the present disclosure evaluate durability by using variation ranges (that is, a numerical change rate, in unit %, after and before a durability test) of the uniform thickness (thickness meter), the planar resistivity, the tensile strength, and the air permeability of the sample of the gas diffusion layer before and after acid corrosion.

In this embodiment of the present disclosure, the gas diffusion layer of the fuel cell may be exposed to an acid environment (such as an acid electrolyte in a proton exchange membrane fuel cell) for a long time, so that good acid corrosion tolerance is required. Through the acid corrosion tolerance test, the acid corrosion tolerance of a plurality of porosity structures can be determined, so as to screen a porosity structure with appropriate acid corrosion tolerance, ensure that the gas diffusion layer has high acid corrosion tolerance and performance stability in the fuel cell, avoid affecting the service life and performance of the gas diffusion layer, and help to select the optimal design scheme.

In some embodiments, for each of the porosity structures, the processor may determine a vertical resistivity and/or a planar resistivity corresponding to the porosity structure. The vertical resistivity is a resistivity of the porosity structure in a direction perpendicular to the gas diffusion layer of the fuel cell. The planar resistivity is a resistivity of the porosity structure in a direction parallel to the gas diffusion layer of the fuel cell.

In this embodiment of the present disclosure, the resistivity is one of the most core indexes that affect the performance of the gas diffusion layer. Reducing the resistivity can effectively reduce the ohmic loss of the fuel cell and improve the conductivity. The ohmic loss is visually manifested by the loss through the heat generation path, which means that the resistivity also affects the thermal management performance of the battery. The planar resistivity is affected by the product preparation process, such as dispersion of fibers, carburization and graphitization. Compared with the planar resistivity, the vertical resistivity has more influence on battery performance due to the direction of electronic transmission. Therefore, during the test, vertical resistivity values at different pressures are often selected to represent the electrical performance. For example, the vertical resistivity value at 1 MPa is common, which helps to determine the assembly pretension. In some embodiments, the resistivity test process may include performing a test using a common resistance test device to obtain a resistivity.

Step 130: calculate, with reference to the evaluation functions and the index weight ratios, performance comprehensive scores of the plurality of porosity structures in the performance evaluation system of the gas diffusion layer of the fuel cell.

The evaluation function is a function or algorithm used to evaluate an evaluation value of a product under the performance evaluation indexes. In some embodiments, for each of the performance evaluation indexes, the test process corresponding to the performance evaluation index may include the evaluation function.

In some embodiments, the evaluation function may include a thickness uniformity evaluation function, an air permeability evaluation function, a drainage capability evaluation function, a tensile strength evaluation function, a compression characteristic evaluation function, a planar resistivity evaluation function, a vertical resistivity evaluation function, a durability evaluation function, or the like.

The thickness uniformity may be evaluated by a thickness variation coefficient x₁ (a standard deviation of the thickness divided by an average thickness). For example, a maximum value Tₘₐₓ of the thickness variation coefficient in the structure design schemes with different porosity distributions is selected as a score lower limit of thickness uniformity, and a minimum value Tₘᵢₙ of the thickness variation coefficient in the structure design schemes with different porosity distributions is selected as a score upper limit of thickness uniformity. That is, a maximum value and a minimum value exist in a plurality of distributed structures with each constant porosity. When the maximum value meets a technical requirement of a first-class product, the evaluation value of thickness uniformity of the structure may be directly determined as a full score.

In some embodiments, the evaluation value of the thickness uniformity may be determined according to the thickness uniformity evaluation function Q₁ and the thickness variation coefficient x₁. For example, the thickness uniformity evaluation function Q₁ is shown in the following formula (3):

$${Q}_{1} = \{ \begin{matrix}40 + \frac{2 \% - {x}_{1}}{2 \% - {T}_{min}} \times 60 , & {T}_{min} \leq {x}_{1} < 2 \% \\ 0 , & {T}_{max} \geq 2 \%\end{matrix} \qquad ( 3 )$$

When a certain index condition is met, it can be seen that the evaluation value of thickness uniformity may be at least 40, and a maximum value may be 60. However, if the thickness uniformity is too poor, that is, the maximum Tₘₐₓ of the thickness variation coefficient is greater than 2%, it is considered that the structure design scheme is prone to cause deviation from the designed index lower limit, and is scored as 0.

In some embodiments, the air permeability x₂ is generally not less than Pₘᵢₙ 200 mL·mm/(cm²·h·mmHg) at the pressure difference 50 Pa. For example, a maximum value of air permeability in the structure design schemes with different porosity distributions may be selected as the upper scoring limit. If a maximum value of the air permeability is greater than 3000 mL·mm/(cm²·h·mmHg), it may be considered that performance of the structure is good enough, and an evaluation value of the air permeability of the structure is determined as a full score.

In some embodiments, the evaluation value of the air permeability may be determined according to the air permeability evaluation function Q₂ and the air permeability x₂. For example, the air permeability evaluation function Q₂ is shown in the following formula (4):

$${Q}_{2} = \{ \begin{matrix}100 , & {x}_{2} \geq 3000 \\ \frac{{x}_{2} - 200}{3000 - 200} \times 100 , & 200 \leq {x}_{2} \leq 3000 \\ 0 , & {P}_{min} \leq 200\end{matrix} \qquad ( 4 )$$

wherein Pₘᵢₙ represents a minimum value of the air permeability at the pressure difference 50 Pa.

The drainage capability may be expressed by a breakthrough pressure x₃. Under different test conditions, the breakthrough pressure of liquid water is about 1 kPa to 7 kPa.

In some embodiments, the evaluation value of the drainage capability may be determined according to the drainage capability evaluation function Q₃ and the breakthrough pressure x₃. For example, the drainage capability evaluation function Q₃ is shown in the following formula (5):

$${Q}_{3} = \{ \begin{matrix}0 , & {x}_{3} > 7 \\ \frac{7 - {x}_{3}}{7 - 1} \times 100 , & 1 \leq {x}_{3} \leq 7 \\ 100 , & {x}_{3} < 1\end{matrix} \qquad ( 5 )$$

In some embodiments, the tensile strength x₄ is generally between 15 MPa and 30 MPa. The tensile strength test process may be performed by clamping the sample of the gas diffusion layer with a universal tester and then applying the tensile force, and recording the breaking tensile force when the gas diffusion layer sample is broken. Then, the tensile strength x₄ is obtained by dividing the breaking tensile force by a width of the sample and a clamping length.

In some embodiments, the evaluation value of the tensile strength may be determined based on the tensile strength evaluation function Q₄ and the tensile strength x₄. For example, the tensile strength evaluation function Q₄ is shown in the following formula (6):

$${Q}_{4} = \{ \begin{matrix}100 , & {x}_{4} > 30 \\ \frac{{x}_{4} - 15}{30 - 15} \times 100 , & 15 \leq {x}_{4} \leq 30 \\ 0 , & {x}_{4} < 15\end{matrix} \qquad ( 6 )$$

In some embodiments, for the compression characteristic x₅, a maximum value θₘₐₓ of the compression characteristic in structure design schemes with different porosity distributions may be selected as a score lower limit of the compression characteristic and a minimum value θₘᵢₙ may be used as a score upper limit of the compression characteristic. For example, the maximum value θₘₐₓ is 30% and the minimum value θₘᵢₙ is 10%.

In some embodiments, the evaluation value of the compression characteristic may be determined according to the compression characteristic evaluation function Q₅ and the compression characteristic x₅. For example, the compression characteristic evaluation function Q₅ is shown in the following formula (7):

$${Q}_{5} = \{ \begin{matrix}0 , & {x}_{5} > 30 \% \\ \frac{30 \% - {x}_{5}}{30 \% - 10 \%} \times 100 , & 10 \% \leq {x}_{5} \leq 30 \% \\ 100 , & {x}_{5} < 10 \%\end{matrix} \qquad ( 7 )$$

In some embodiments, a current planar resistivity x₆ is generally not greater than 30mΩ·cm, some are less than 5mΩ·cm.

In some embodiments, the evaluation value of the planar resistivity may be determined based on the planar resistivity evaluation function Q₆ and the current planar resistivity x₆. For example, the planar resistivity evaluation function Q₆ is shown in the following formula (8):

$${Q}_{6} = \{ \begin{matrix}0 , & {x}_{6} > 30 \\ \frac{30 - {x}_{6}}{30 - 5} \times 100 , & 5 \leq {x}_{6} \leq 30 \\ 100 , & {x}_{6} < 5\end{matrix} \qquad ( 8 )$$

In some embodiments, a current vertical resistivity is generally between 200mΩ·cm˜500mΩ·cm. In some embodiments, the evaluation value of the vertical resistivity may be determined based on the vertical resistivity evaluation function Q₇ and the current vertical resistivity x₇. For example, the vertical resistivity evaluation function Q₇ is shown in formula (9):

$${Q}_{7} = \{ \begin{matrix}0 , & {x}_{7} > 500 \\ \frac{500 - {x}_{7}}{500 - 200} \times 100 , & 200 \leq {x}_{7} \leq 500 \\ 100 , & {x}_{7} < 200\end{matrix} \qquad ( 9 )$$

In some embodiments, durability evaluation may be performed by a plurality of properties of the sample of the gas diffusion layer with different porosity distributions before and after durability tests, such as variation ranges of acid corrosion tolerance, thickness uniformity, plane direction resistivity, tensile strength, and air permeability.

In some embodiments, an evaluation value of durability may be determined according to durability evaluation functions Q₈-Q₁₁, a variation range of thickness uniformity x₈, a variation range of planar resistivity x₉, a variation range of tensile strength x₁₀, and a variation range of air permeability x₁₁. For example, the durability evaluation functions Q₈-Q₁₁ are shown in the following formula (10):

$${Q}_{i} = \{ \begin{matrix}0 , & {x}_{i} > 80 \% \\ \frac{80 \% - {x}_{i}}{80 \% - 20 \%} \times 100 , & 20 \% \leq {x}_{i} \leq 80 \% \\ 100 , & {x}_{i} < 20 \%\end{matrix} \qquad ( 10 )$$

where, Qᵢ represents an evaluation function of a performance evaluation index whose number is i, xᵢ represents a variation range whose number is i, and i in the formula (10) may be 8, 9, 10, 11. X₈ represents a variation range of thickness uniformity, x₉ represents a variation range of planar resistivity, x₁₀ represents a variation range of tensile strength, and x₁₁ represents a variation range of air permeability. The durability evaluation functions include an evaluation function of the variation range of thickness uniformity represented by Q₈, an evaluation function of the variation range of planar resistivity represented by Q₉, an evaluation function of the variation range of tensile strength represented by Q₁₀, and an evaluation function of the variation range of air permeability represented by Q₁₁.

In some embodiments, the evaluation values of durability obtained by means of calculation according to the durability evaluation functions may include an evaluation value of the variation range of thickness uniformity, an evaluation value of the variation range of planar resistivity, an evaluation value of the variation range of tensile strength, and an evaluation value of the variation range of air permeability.

The index weight ratio refers to a ratio of a performance evaluation index to all performance evaluation indexes in the performance evaluation system.

The performance comprehensive score refers to a comprehensive score of a plurality of performance evaluation indexes of the porosity structure obtained under the performance evaluation system.

In some embodiments, the processor may obtain, for each of the performance evaluation indexes, an evaluation function of the performance evaluation index in the gas diffusion layer of the fuel cell, and obtain an evaluation value of the performance evaluation index by means of calculation; assign an index weight ratio to the performance evaluation index according to the importance of the performance evaluation index to the fuel cell performance; and calculate performance comprehensive scores of a plurality of porosity structures in the performance evaluation system of the gas diffusion layer of the fuel cell; obtain, by using the evaluation function and the index weight ratio, a performance comprehensive score of the structure design schemes with different porosity distributions to obtain the optimal design scheme.

In some embodiments, after the evaluation function is obtained, the processor may assign an index weight ratio to each performance evaluation index. For example, the index weight ratio may be assigned according to the importance of the performance evaluation index to the fuel cell performance, and the index weight ratios are shown in Table 1.

TABLE 1
Table of index weight ratios

| Number i | Performance evaluation index | Index weight ratio |
|---|---|---|
| 1 | Thickness uniformity | 6% |
| 2 | Air permeability | 10% |
| 3 | Drainage capacity | 12% |
| 4 | Tensile strength | 8.50% |
| 5 | Compression characteristic | 12.50% |
| 6 | Vertical resistivity | 12% |
| 7 | Planar resistivity | 9% |
| 8 | Variation range of thickness uniformity | 6% |
| 9 | Variation range of planar resistivity | 6% |
| 10 | Variation range of tensile strength | 9% |
| 11 | Variation range of air permeability | 9% |

In some embodiments, evaluation functions and index weight ratios may be used to obtain the performance comprehensive score of structure design schemes with different porosity distributions to obtain the optimal design scheme.

In some embodiments, the calculation manner of the performance comprehensive score includes: obtaining the performance comprehensive score by means of calculation according to the evaluation value and the index weight ratio of the performance evaluation index. For example, the performance comprehensive score may be calculated according to the following formula (11):

$$Q = {Σ}_{i = 1}^{11} {Q}_{i} \times {y}_{i} \qquad ( 11 )$$

where Q represents the performance comprehensive score of the structure design schemes with different porosity distributions, yᵢ represents the index weight ratio of the performance evaluation index whose number is i, Qᵢ represents the evaluation function and the corresponding evaluation value of the performance evaluation index whose number is i.

In the embodiment of the present disclosure, the selection of the optimal design scheme from structure design schemes with different porosity distributions is based on the evaluation functions and index weights, in addition to the performance evaluation system. It is calculated based on the test results and the constructed evaluation functions and index weight ratios. A product of the structure design scheme with different porosity distributions is comprehensively scored to obtain the performance comprehensive scores, so as to obtain the optimal design solution. A single score of each performance evaluation index is up to 100, and an evaluation value of the performance evaluation index is multiplied by an index weight ratio, so as to be weighted obtain a final score of the performance comprehensive score.

Step 140: determine an optimal design scheme in the plurality of porosity structures according to the performance comprehensive scores.

The optimal design scheme refers to a design scheme corresponding to a porosity structure with a highest performance comprehensive score in a plurality of porosity structures.

In some embodiments, the processor may select a porosity structure with a highest performance comprehensive score from the performance comprehensive scores corresponding to the plurality of porosity structures as the optimal design scheme. For example, the processor may arrange the plurality of porosity structures according to the performance comprehensive scores from high to low, and select a first porosity structure (that is, a porosity structure with the highest performance comprehensive score) as the optimal design scheme.

In this embodiment of the present disclosure, it calculates the performance comprehensive scores of the plurality of porosity structures in the performance evaluation system of the gas diffusion layer of the fuel cell, so as to determine the optimal design scheme in the plurality of porosity structures. It can not only select an optimal fuel cell product design, but also identify a difference of performance indexes between different fuel cell product designs. A direction of optimal design of the fuel cell product is guided by compensating a shortcoming.

It should be noted that the foregoing description of the process 100 is merely for example and description, and does not limit the scope of the present disclosure. A person skilled in the art may make various modifications and changes to the process 100 under the guidance of the present disclosure. However, these amendments and changes are still within the scope of the present disclosure.

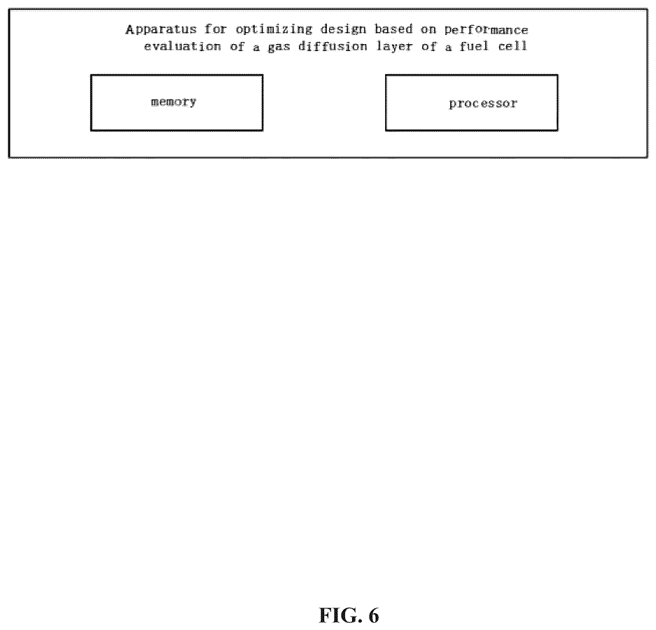

FIG. 6 is an exemplary schematic structural diagram of an apparatus for optimizing design based on a performance evaluation of a gas diffusion layer of a fuel cell according to some embodiments of the present disclosure.

In some embodiments, as shown in FIG. 6, the apparatus for optimizing design based on performance evaluation of a gas diffusion layer of a fuel cell includes at least one processor and at least one memory, the at least one memory is configured to store computer instructions, and the at least one processor is configured to execute at least a part of instructions in the computer instructions to implement the method for optimizing design based on performance evaluation of a gas diffusion layer of a fuel cell in any embodiment of the present disclosure.

In some embodiments, in the method for optimizing design based on performance evaluation of a gas diffusion layer of a fuel cell according to an embodiment of the present disclosure, test data of three samples of gas diffusion layer with a same overall porosity but different structure designs are selected, and a complete process 100 is performed. The three samples of gas diffusion layer include a first-stepped porosity structure, a second-stepped porosity structure, and an ordered porosity structure, which are respectively represented as A, B, and C. The detailed description is as follows.

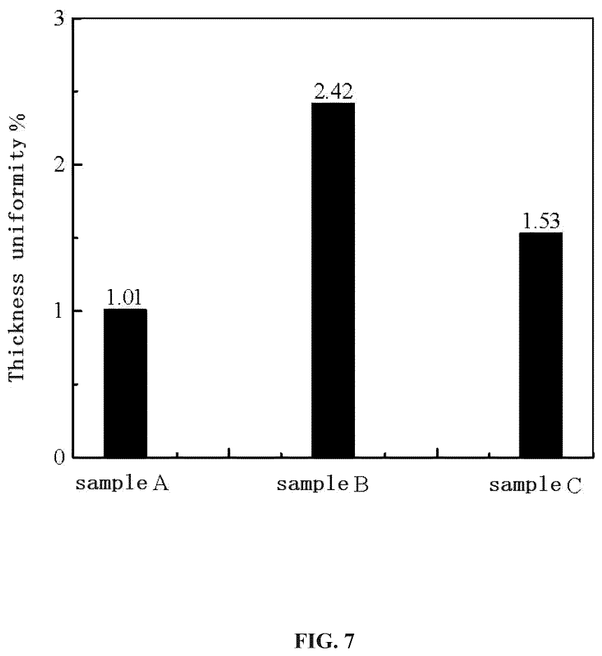

FIG. 7 is an exemplary diagram of a test result of thickness uniformity according to some embodiments of the present disclosure. A horizontal coordinate in FIG. 7 is a sample number, and a vertical coordinate is thickness uniformity. It is calculated by using formula (3), Tₘᵢₙ=1.01%, and Tₘₐₓ=2.42%. It is obtained that an evaluation value of thickness uniformity of sample A is 100, an evaluation value of thickness uniformity of sample B is 0 and an evaluation value of thickness uniformity of sample C is 68.48.

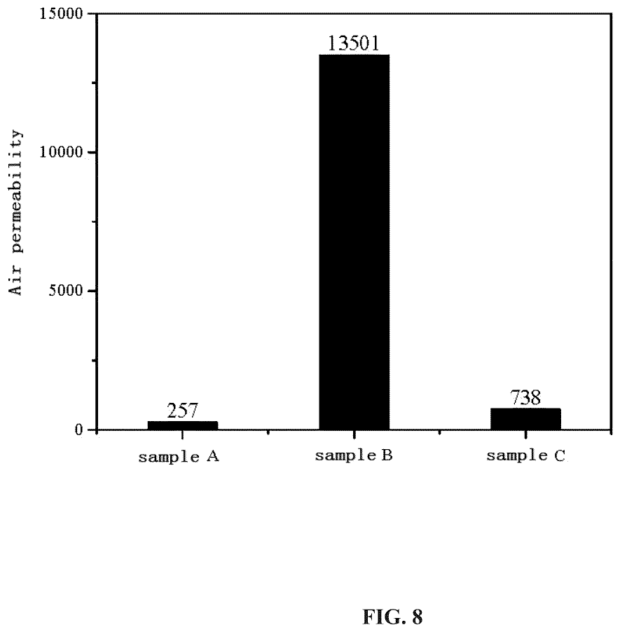

FIG. 8 is an exemplary diagram of a test result of air permeability according to some embodiments of the present disclosure. A horizontal coordinate in FIG. 8 is a sample number, and a vertical coordinate is air permeability. It is calculated by using formula (4), to obtain that an evaluation value of air permeability of sample A is 2.04, an evaluation value of air permeability of sample B is 100, and an evaluation value of air permeability of sample C is 19.2.

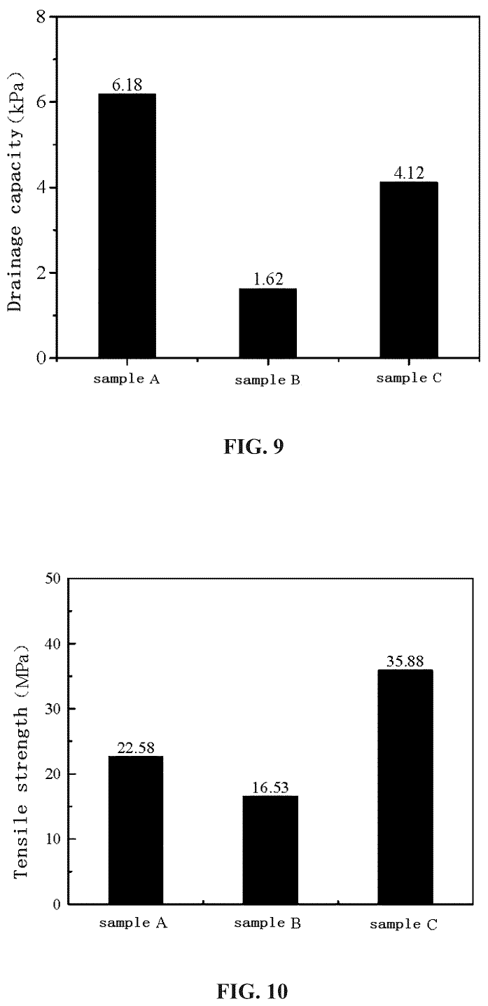

FIG. 9 is an exemplary diagram of a test result of drainage capability according to some embodiments of the present disclosure. A horizontal coordinate in FIG. 9 is a sample number, and a vertical coordinate is a drainage capability. It is calculated by using formula (5), to obtain that an evaluation value of a drainage capability of sample A is 13.67, an evaluation value of a drainage capability of sample B is 89.67, and an evaluation value of a drainage capability of sample C is 48.

FIG. 10 is an exemplary diagram of a test result of tensile strength according to some embodiments of the present disclosure A horizontal coordinate in FIG. 10 is a sample number, and a vertical coordinate is a tensile strength. It is calculated by using formula (6), to obtain that an evaluation value of the tensile strength of the sample A is 49.47, an evaluation value of the tensile strength of the sample B is 10.2, and an evaluation value of the tensile strength of the sample C is 100.

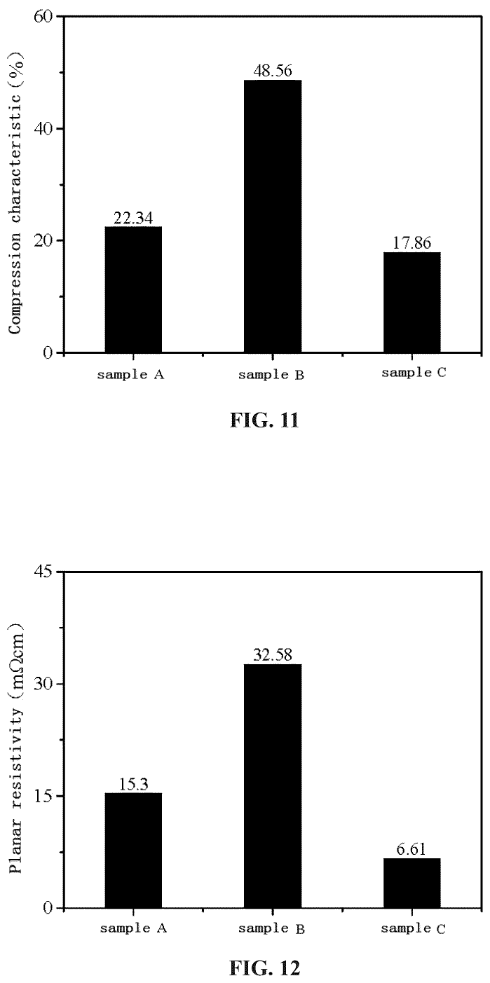

FIG. 11 is an exemplary schematic diagram of a test result of compression characteristic according to some embodiments of the present disclosure. A horizontal coordinate in FIG. 11 is a sample number, and a vertical coordinate is a compression characteristic. It is calculated by using formula (7), to obtain that an evaluation value of a compression characteristic of the sample A is 38.30, an evaluation value of a compression characteristic of the sample B is 0, and an evaluation value of a compression characteristic of the sample C is 60.70.

FIG. 12 is an exemplary schematic diagram of a test result of a planar resistivity according to some embodiments of the present disclosure. A horizontal coordinate in FIG. 12 is a sample number, and a vertical coordinate is a planar resistivity. It is calculated by using formula (8), to obtain that an evaluation value of the planar resistivity of the sample A is 58.80, an evaluation value of the planar resistivity of the sample B is 0, and an evaluation value of the planar resistivity of the sample C is 93.56.

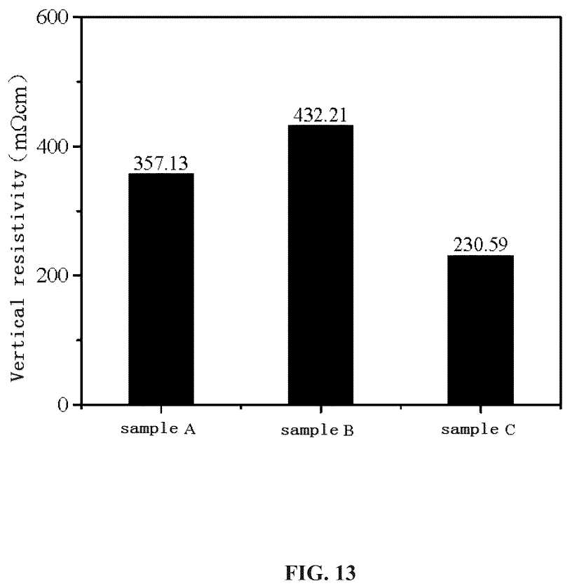

FIG. 13 is an exemplary schematic diagram of a test result of vertical resistivity according to some embodiments of the present disclosure. A horizontal coordinate in FIG. 13 is a sample number, and a vertical coordinate is a vertical resistivity. It is calculated by using formula (9), to obtain that an evaluation value of the vertical resistivity of the sample A is 47.62, an evaluation value of the vertical resistivity of the sample B is 22.60, and an evaluation value of the vertical resistivity of the sample C is 89.80.

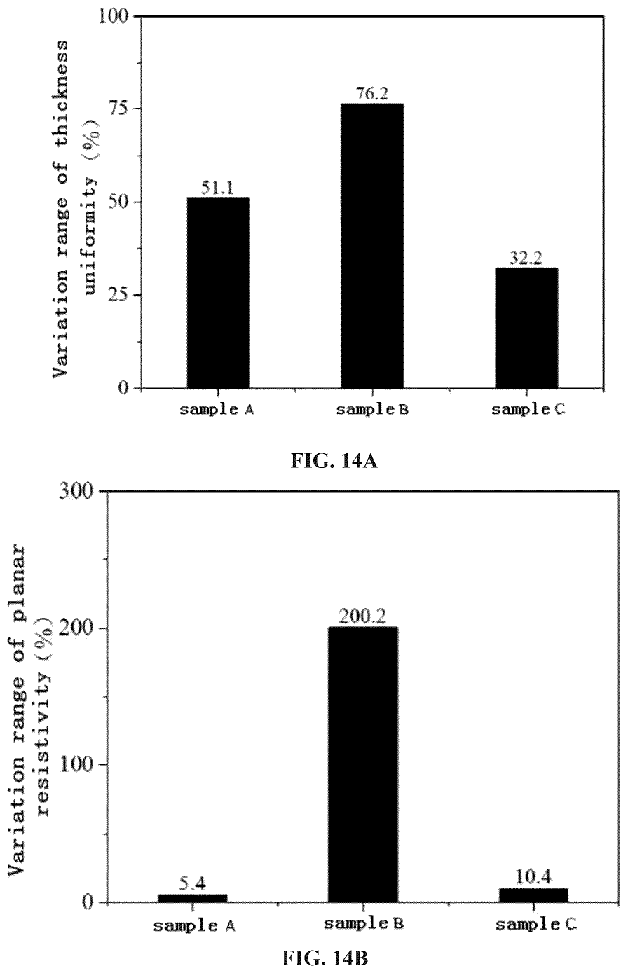

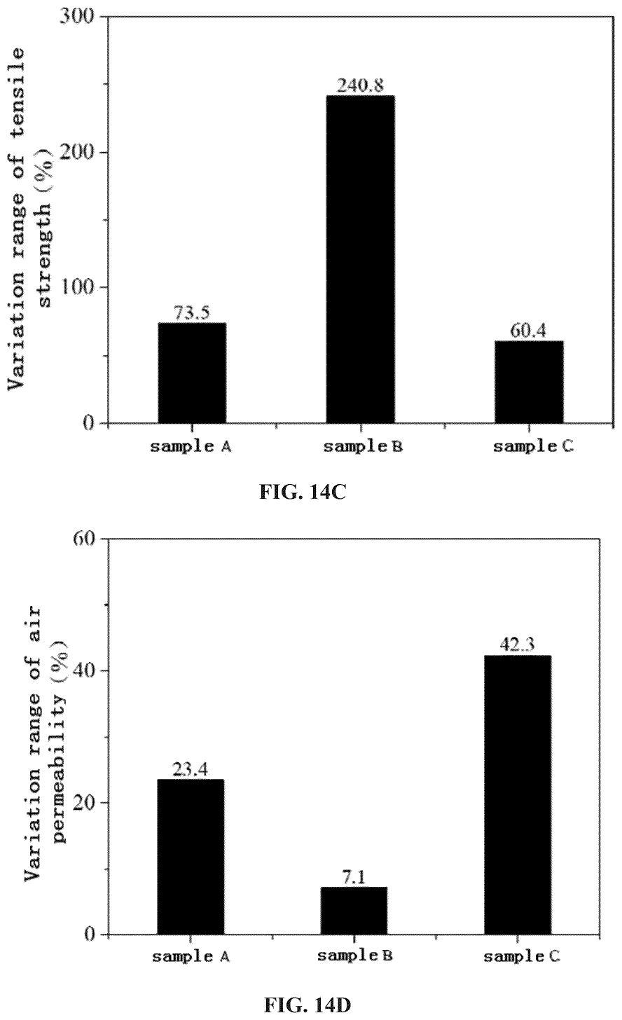

FIGS. 14A-14D are exemplary schematic diagrams of test results of acid corrosion tolerance according to some embodiments of the present disclosure. FIG. 14A shows a test result of a variation range of thickness uniformity of the sample, where a horizontal coordinate is a sample number, and a vertical coordinate is the variation range of the thickness uniformity. FIG. 14B shows a test result of a variation range of planar resistivity of a sample, where a horizontal coordinate is a sample number, and a vertical coordinate is the variation range of the planar resistivity. FIG. 14C shows a test result of a variation range of tensile strength of a sample, where a horizontal coordinate is a sample number, and a vertical coordinate is the variation range of the tensile strength change amplitude. FIG. 14D shows a test result of a variation range of air permeability. The horizontal coordinate is the sample number and the vertical coordinate is the variation range of the air permeability. It is calculated by using the formula (10) to obtain:

An evaluation value of the variation range of the thickness uniformity of the sample A is 48.17, an evaluation value of the variation range of the thickness uniformity of the sample B is 6.33, and an evaluation value of the variation range of the thickness uniformity of the sample C is 79.67.

The evaluation value of the variation range of the planar resistivity of the sample A is 100, the evaluation value of the variation range of the planar resistivity of the sample B is 0, and the evaluation value of the variation range of the planar resistivity of the sample C is 100.

The evaluation value of the variation range of the tensile strength of the sample A is 10.83, the evaluation value of the variation range of the tensile strength of the sample B is 0, and the evaluation value of the variation range of the tensile strength of the sample C is 32.67.

The evaluation value of the variation range of the air permeability of the sample A is 94.33, the evaluation value of the variation range of the air permeability of the sample B is 100, and the evaluation value of the variation range of the air permeability of the sample C is 62.17.

In combination with the foregoing calculation results and Table 1, the performance comprehensive score of each sample may be calculated by using the formula (11), as shown in the following Table 2:

TABLE 2
Calculation of performance comprehensive score

| number | | Weight | Score of | Score of | Score of |
|---|---|---|---|---|---|
| i | Index | ratio | sample A | sample B | sample C |
| 1 | Thickness uniformity | 6% | 100 | 0 | 68.48 |
| 2 | Air permeability | 10% | 2.04 | 100 | 19.2 |
| 3 | Drainage capacity | 12% | 13.67 | 89.67 | 48 |
| 4 | Tensile strength | 8.5% | 49.47 | 10.2 | 100 |
| 5 | Compression | 12.5% | 38.30 | 0 | 60.70 |
| | characteristic | | | | |
| 6 | Vertical resistivity | 12% | 58.80 | 0 | 93.56 |
| 7 | Planar resistivity | 9% | 47.62 | 22.60 | 89.80 |
| 8 | Variation range of | 6% | 48.17 | 6.33 | 79.67 |
| | thickness uniformity | | | | |
| 9 | Variation range of | 6% | 100 | 0 | 100 |
| | planar resistivity | | | | |
| 10 | Variation range of | 9% | 10.83 | 0 | 32.67 |
| | tensile strength | | | | |
| 11 | Variation range of | 9% | 94.33 | 100 | 62.17 |
| | air permeability | | | | |

| | | | |
|---|---|---|---|
| Performance comprehensive score | 46.53 | 33.04 | 66.50 |

By using the formula (11), the comprehensive performance score of the sample A is calculated as =6%×100+10%×2.04+12% 13.67+8.5%×49.47+12.5%×38.3+12%×58.8+9%×47.62+6%×48.17+6%×100+9%×10.83+9%×94.33-46.53. Similarly, the performance comprehensive score of the sample B is 33.04 points, and the performance comprehensive score of the sample C is 66.50. Therefore, with the same overall porosity, the sample C has better performance, and a design scheme of the sample C may be selected as the optimal design scheme.

It may be further learned from Table 2 that respective evaluation values of the thickness uniformity, the compression characteristic, the vertical resistivity, the variation range of planar resistivity, and the variation range of the tensile strength for the sample B are zero, which has a great impact on the performance.

In this embodiment of the present disclosure, it can not only screen an optimal product design, but also know a difference of performance indexes between different product designs, and a direction of optimal design of the product is guided by compensating a shortcoming.

One or more embodiments of the present disclosure further provide a computer readable storage medium, where the storage medium stores computer instructions, and when the computer reads the computer instructions in the storage medium, the computer executes the method for optimizing design based on performance evaluation of a gas diffusion layer of a fuel cell according to any embodiment of the present disclosure.

A specific implementation of the present disclosure is described in detail above, but is merely used as an example. The present disclosure is not limited to the specific implementation described above. For a person skilled in the art, any equivalent modification or replacement of the present disclosure is also within the scope of the present disclosure. Therefore, an equivalent transformation, modification, or improvement made without departing from the spirit and principle of the present disclosure shall fall within the scope of the present disclosure.

The foregoing describes a basic concept. Apparently, for a person skilled in the art, the foregoing detailed disclosure is merely an example, but does not constitute a limitation on the present disclosure. Although not expressly stated herein, a person skilled in the art may make various modifications, improvements and amendments to the present disclosure. Such modifications, improvements, and amendments are proposed in the present disclosure. Therefore, such modifications, improvements, and amendments are still within the spirit and scope of the exemplary embodiments of the present disclosure.

Meanwhile, specific words are used in the present disclosure to describe the embodiments of the present disclosure. For example, “one embodiment”, “an embodiment”, and/or “some embodiments” mean a feature, structure, or characteristic related to at least one embodiment of the present disclosure. Therefore, it should be emphasized and noted that “one embodiment” or “an embodiment” or “one alternative embodiment” mentioned twice or more times in different locations in the present disclosure does not necessarily refer to the same embodiment. In addition, some features, structures, or characteristics in one or more embodiments of the present disclosure may be appropriately combined.

In addition, unless expressly stated in the claims, the sequence of the processing elements and sequences described in the present disclosure, the use of numeric letters, or the use of other names are not intended to limit the sequence of the processes and methods described in the present disclosure. Although some presently considered useful embodiments of the invention are discussed in various examples in the foregoing disclosure, it should be understood that such details are for illustrative purposes only, that the additional claims are not limited to the disclosed embodiments, and that the claims are intended to cover all modifications and equivalent combinations that conform to the substance and scope of the embodiments of the present disclosure. For example, although the system components described above may be implemented by a hardware device, they may be implemented only by a software solution, such as installing the described system on an existing server or mobile device.

Similarly, it should be noted that, in order to simplify the description disclosed in the present disclosure and thereby help understand one or more embodiments of the present disclosure, in the foregoing description of the embodiments of the present disclosure, various features are sometimes incorporated into one embodiment, the accompanying drawings, or descriptions thereof. However, this disclosure method does not mean that the feature required by the object of the present disclosure is more than the feature mentioned in the claims. In fact, the features of the embodiments are less than all the features of the individual embodiments disclosed above.

Some embodiments use numbers describing the composition, number of attributes, and it is to be understood that such numbers are used for the description of embodiments, and in some examples the modifiers “approximately”, “about” or “generally” are used. Unless otherwise stated, “approximately”, “about” or “generally” indicates that the number allows for a change in ±20%. Correspondingly, in some embodiments, numeric parameters used in the present disclosure and claims are approximations, and the approximations may be changed according to features required by individual embodiments. In some embodiments, numeric parameters should take into account the specified significant digits and adopt a general digit retention method. Although the range of values and parameters used in some embodiments of the present disclosure to determine their range breadth are approximations, in specific embodiments, such values are set as precisely as possible.

The present disclosure is incorporated herein by reference in its entirety into each patent, patent application, patent application publication and other materials, such as articles, books, instructions, publications, documents, etc. Except for the application history documents that are inconsistent with or conflict with the contents of the present disclosure, the documents with the widest scope of the claims of the present disclosure are limited (currently or later attached to the present disclosure). It should be noted that, if the description, definition, and/or use of a term in the auxiliary material of the present disclosure is inconsistent or conflicting with the content of the present disclosure, the description, definition, and/or use of the term of the present disclosure shall prevail.

Finally, it should be understood that the embodiments described in the present disclosure are merely used to describe the principles of the embodiments of the present disclosure. Other variations may fall within the scope of the present disclosure. Therefore, by way of example and not limitation, alternative configurations of embodiments of the present disclosure may be considered to be consistent with the teachings of the present disclosure. Correspondingly, the embodiments of the present disclosure are not limited to the embodiments specifically described and described in the present disclosure.

1. A method for optimizing design based on performance evaluation of a gas diffusion layer of a fuel cell, comprising:
determining an overall porosity of the gas diffusion layer of the fuel cell according to production requirements, and obtaining a plurality of porosity structures with the overall porosity;
obtaining performance evaluation indexes of the gas diffusion layer of the fuel cell, and constructing a performance evaluation system for the gas diffusion layer of the fuel cell;
calculating, with reference to evaluation functions and index weight ratios, performance comprehensive scores of the plurality of porosity structures in the performance evaluation system of the gas diffusion layer of the fuel cell;
determining an optimal design scheme in the plurality of porosity structures according to the performance comprehensive scores;
wherein the plurality of porosity structures at least comprise:
a first-stepped porosity structure, a second-stepped porosity structure, and an ordered porosity structure;
the first-stepped porosity structure is that the porosity of each layer in the gas diffusion layer decreases linearly from top to bottom;
the second-stepped porosity structure is that the porosity of each layer in the gas diffusion layer increases linearly from top to bottom;
the ordered porosity structure is that the porosity of each layer in the gas diffusion layer is evenly distributed from top to bottom;
the performance evaluation indexes of the gas diffusion layer of the fuel cell comprise at least: characteristic performance indexes, mechanical performance indexes, electrical performance indexes, and durability performance indexes;
the characteristic performance indexes comprise an air permeability and a drainage capability of the gas diffusion layer of the fuel cell; the drainage capability of the gas diffusion layer is represented by testing a breakthrough pressure of liquid water, including:
determining the drainage capability of the gas diffusion layer according to a drainage capability test apparatus; wherein,
the drainage capability test apparatus includes a water injection pipeline, a solution pool, an air source pressure pipeline, and a test fixture;
the water injection pipeline is connected to the solution pool; the water injection pipeline is used to inject red stained water into the solution pool;
the solution pool is used to contain the liquid water injected by the water injection pipeline; a channel is disposed above the solution pool; a lower end of the channel is located above the solution pool; an upper end of the channel is connected to the gas diffusion layer of the fuel cell clamped in the test fixture; the test fixture is used to hold and fix the gas diffusion layer of the fuel cell to be tested; the air source pressure pipeline is connected to the water injection pipeline through a removable pipeline connection; the air source pressure pipeline is used to provide gas pressure;
using the breakthrough pressure of testing liquid water to represent the drainage capability of the gas diffusion layer of the fuel cell, including:
injecting the red stained water into the solution pool before testing, when an injected liquid level is at a position of a channel above the solution pool, closing a check valve in the water injection pipeline;
connecting the water injection pipeline to the air source pressure pipeline, clamping the gas diffusion layer of the fuel cell with the plurality of porosity structures into the test fixture, and disposing a white water-absorbing filter paper in an upper cavity;
opening a cut-off valve in the water injection pipeline and a relief valve in the air source pipeline, and adjusting to an appropriate pressure; and
opening the check valve and the cut-off valve, slowly adjusting a micro-pressure difference gauge from a low pressure to a high pressure, and recording, a pressure of the micro-pressure difference gauge when the white water-absorbing filter paper turns red, as the breakthrough pressure of the liquid water;
the mechanical performance indexes comprise a tensile strength and a compression characteristic of the gas diffusion layer of the fuel cell; the electrical performance indexes comprise a vertical resistivity and a planar resistivity of the gas diffusion layer of the fuel cell;
the durability performance indexes comprise acid corrosion tolerance of the gas diffusion layer of the fuel cell;
the calculating, with reference to the evaluation functions and the index weight ratios, the performance comprehensive scores of the plurality of porosity structures in the performance evaluation system of the gas diffusion layer of the fuel cell, further comprises:
obtaining an evaluation function for each of the performance evaluation indexes of the gas diffusion layer of the fuel cell, and calculating an evaluation value of each of the performance evaluation indexes;
assigning an index weight ratio to each of the performance evaluation indexes according to importance of each of the performance evaluation indexes to fuel cell performance;
calculating the performance comprehensive scores of the plurality of porosity structures in the performance evaluation system of the gas diffusion layer of the fuel cell;
obtaining a performance comprehensive score of structure design schemes with different porosity distributions by using the evaluation functions and index weight ratios, so as to obtain the optimal design scheme; and
a calculation manner of the performance comprehensive score comprises:
calculating the performance comprehensive score according to the evaluation value and the index weight ratio of the performance evaluation index, the calculation manner being show as following formula,
$$Q = {Σ}_{i = 1}^{11} {Q}_{i} \times {y}_{i} ;$$
wherein, Q is the performance comprehensive score of the structure design schemes with different porosity distributions, Qᵢ represents an evaluation function of a performance evaluation index whose number is i.

2. The method for optimizing design based on the performance evaluation of the gas diffusion layer of the fuel cell according to claim 1, wherein the air permeability is a core performance index of the gas diffusion layer, the method further comprising:
using an air permeability meter, comparing performance differences of the plurality of porosity structures under the same pressure difference by using a constant pressure difference manner.

3. (canceled)

4. The method for optimizing design based on the performance evaluation of the gas diffusion layer of the fuel cell according to claim 1, wherein:
the tensile strength reflects characteristics of a manufacturing process of the gas diffusion layer of the fuel cell, and performance of the tensile strength depends on a strength of a carbon fiber itself and a carbonized strength of impregnated binder, the tensile strength is obtained by testing using a universal tester;
the compression characteristic is obtained by calculating a difference between an initial thickness without pressure and a thickness after a plurality of compressions, of the gas diffusion layer of the fuel cell with the plurality of porosity structures.

5. The method for optimizing design based on the performance evaluation of the gas diffusion layer of the fuel cell according to claim 4, wherein:
the acid corrosion tolerance comprises variation ranges of thickness uniformity, planar resistivity, the tensile strength, the air permeability of the gas diffusion layer of the fuel cell before and after acid corrosion.

6. An apparatus for optimizing design based on performance evaluation of a gas diffusion layer of a fuel cell, comprising:
at least one processor, and
at least one memory, the at least one memory being configured to store computer instructions, and the at least one processor being configured to execute at least a part of instructions in the computer instructions to implement the method for optimizing design based on the performance evaluation of the gas diffusion layer of the fuel cell according to claim 1.

7. The method for optimizing design based on the performance evaluation of the gas diffusion layer of the fuel cell according to claim 1, wherein after determining the optimal design scheme, the method further comprising:
generating a set of manufacturing parameters corresponding to the optimal design scheme for controlling manufacturing of the gas diffusion layer of the fuel cell.
